(19) United States
(12) Patent Application Publication
(10) Pub. No.: US 2024/0002607 A1
(43) Pub. Date: Jan. 4, 2024

(54) POLYMETALLOXANE, COMPOSITION OF SAME, CURED FILM, METHOD OF PRODUCING THE CURED FILM, MEMBER AND ELECTRONIC COMPONENT EACH PROVIDED WITH THE CURED FILM, FIBER, AND METHOD OF PRODUCING THE FIBER

(71) Applicant: Toray Industries, Inc., Tokyo (JP)

(72) Inventors: Jun Oura, Otsu-shi, Shiga (JP); Yohei Konoshima, Otsu-shi, Shiga (JP); Mitsuhito Suwa, Otsu-shi, Shiga (JP); Toru Okazawa, Otsu-shi, Shiga (JP)

(21) Appl. No.: 18/038,040

(22) PCT Filed: Dec. 20, 2021
(86) PCT No.: PCT/JP2021/046961

§ 371 Date: May 22, 2023

(30) Foreign Application Priority Data
Dec. 25, 2020 (JP) 2020-216349

(51) Int. Cl. C08G 79/10; C09D 185/00; C04B 35/48; C04B 35/64; D01F 9/10; D01F 6/76

(52) U.S. Cl. CPC C08G 79/10; C09D 185/00; C04B 35/48; C04B 35/64; D01F 9/10; D01F 6/76; C04B 2235/3248; D10B 2101/08

(57) ABSTRACT

A polymetalloxane including structural units represented by formulae (1-1) and (1-2), and having a weight-average molecular weight of 30,000 or more and 2,000,000 or less;

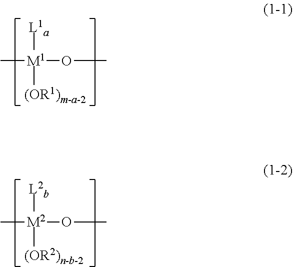

wherein, M¹ and M² independently represent different metal atoms; L¹ and L² are each independently a group selected from the group consisting of an allyloxy group, an aryloxy group, and a trialkylsiloxy group; L¹ and L² may be the same or different, and at least one thereof is an allyloxy group or an aryloxy group; R¹ and R² are each independently a hydrogen atom, a C₁₋₁₂ alkyl group, or a group having a metalloxane bond; m is an integer that represents the valence of the metal atom M¹, and a is an integer of 1 to (m−2); and n is an integer that represents the valence of the metal atom M², and b is an integer of 1 to (n−2).

### TECHNICAL FIELD

This disclosure relates to: a polymetalloxane; a composition of the polymetalloxane; a cured film and a method of producing the cured film; a member and an electronic component that each include the cured film; and a fiber and a method of producing the fiber.

### BACKGROUND

A film composed of a metal oxide has properties such as a high heat resistance, a high transparency, a high refractive index and the like, and is promisingly expected to have properties useful for various applications.

Examples of a known method of forming such a film include; a method of forming a film of titanium oxide or zirconium oxide by a gas-phase process such as chemical vapor deposition (CVD); and the like. In a gas-phase process such as CVD, however, a film forming rate is low, and it is difficult to obtain an industrially usable film thickness.

On the other hand, there has been proposed a method in which a metal alkoxide is hydrolyzed in a solvent, and the resulting hydrolysates are polycondensed to yield a polymetalloxane, which is applied and cured to obtain a thin film having a high transparency and a high refractive index. However, hydrolyzing a metal alkoxide usually causes the resulting hydrolysates to aggregate and become prone to be insoluble in an organic solvent. Accordingly, that which is being proposed is that a monofunctional silane compound such as trimethylsilane, is introduced into a side chain of a metal molecule of a polymetalloxane to enable the polymetalloxane to be present stably in a transparent and uniform state in a solution, and form a homogeneous cured film (for example, see WO 2017/90512).

In a method described in WO '512, having a side chain that is a specific group such as a trialkylsiloxy group, makes it possible to obtain a polymetalloxane that can be present stably in a uniform state in a solution. However, when a polymetalloxane contains two or more kinds of metals, the metals, depending on the kind thereof, facilitate the elimination of the trialkylsilanol during the hydrolysis reaction, and thus cause a problem in that the compounds eliminated aggregate, making it difficult to perform polycondensation stably.

It could therefore be helpful to provide, at a low cost, a polymetalloxane that has a high molecular weight, can be present stably in a uniform state in a solution, and can be supplied industrially stably.

### SUMMARY

We thus provide a polymetalloxane including structural units represented by general formula (1-1) and general formula (1-2), and having a weight-average molecular weight of 30,000 or more and 2,000,000 or less:

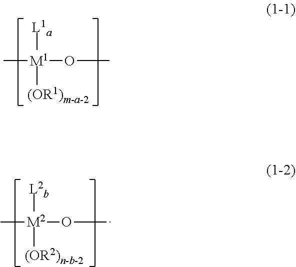

In generale formula (1-1) and (1-2), M¹ and M² each represent different metal atoms each selected from the group consisting of Al, Sc, Ti, V, Cr, Mn, Fe, Co, Ni, Cu, Zn, Ga, Ge, Y, Zr, Nb, Mo, In, Sn, Sb, Hf, Ta, W, and Bi; L¹ and L² are each independently a group selected from the group consisting of an allyloxy group, an aryloxy group, and a trialkylsiloxy group; L¹ and L² may be the same or different, and at least one thereof is an allyloxy group or an aryloxy group; R¹ and R² are each independently a hydrogen atom, a C₁₋₁₂ alkyl group, or a group having a metalloxane bond; m is an integer that represents the valence of the metal atom M¹, and a is an integer of 1 to (m−2); and n is an integer that represents the valence of the metal atom M², and b is an integer of 1 to (n−2).

Our polymetalloxane obtained by our method contains two or more metals having a large molecular weight, and is present stably in a transparent and uniform state in a solution. Accordingly, we achieve the effect of making it possible to provide a polymetalloxane that can be supplied industrially stably.

In addition, our polymetalloxane makes it possible to provide a cured film having a high refractive index and a high crack resistance.

### DETAILED DESCRIPTION

Below, examples will be described in detail. However, this disclosure should not be limited to the below-mentioned examples and can be carried out with various modifications, depending on the purpose and the usage.

### Polymetalloxane

A polymetalloxane according to an example includes structural units represented by general formulae (1-1) and (1-2):

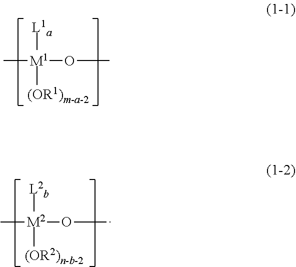

In general formulae (1-1) and (1-2), M¹ and M² independently represent different metal atoms each selected from the group consisting of Al, Sc, Ti, V, Cr, Mn, Fe, Co, Ni, Cu, Zn, Ga, Ge, Y, Zr, Nb, Mo, In, Sn, Sb, Hf, Ta, W, and Bi; L¹ and L² are each independently a group selected from the group consisting of an allyloxy group, an aryloxy group, and a trialkylsiloxy group; L¹ and L² may be the same or different, and at least one thereof is an allyloxy group or an aryloxy group; R¹ and R² are each independently a hydrogen atom, a C₁₋₁₂ alkyl group, or a group having a metalloxane bond; m is an integer that represents the valence of the metal atom M¹, and a is an integer of 1 to (m−2); and n is an integer that represents the valence of the metal atom M², and b is an integer of 1 to (n−2).

A group having a metalloxane bond means that R¹ or R² is bound directly to a metal atom M¹ or M² of another polymetalloxane chain.

Specific examples of the aryloxy group include a phenoxy group and the like. Specific examples of the allyloxy group include an acetyl acetonate group, an ethyl acetoacetate group and the like. Specific examples include a group represented by general formula (2) below. Specific examples of the trialkylsiloxy group include a trihydroxysiloxy group, a trimethylsiloxy group, a triethylsiloxy group, a tripropylsiloxy group, a triisopropylsiloxy group, a tributylsiloxy group, a triisobutylsiloxy group, a tri-s-butylsiloxy group, a tri-t-butylsiloxy group, a tricyclohexylsiloxy group, a trimethoxysiloxy group, a triethoxysiloxy group, a tripropoxysiloxy group, a triisopropoxysiloxy group, a tributoxysiloxy group, a triphenylsiloxy group, a hydroxydiphenylsiloxy group, a methyldiphenylsiloxy group, an ethyldiphenylsiloxy group, a propyldiphenylsiloxy group, a dihydroxy(phenyl)siloxy group, a dimethyl(phenyl)siloxy group, a diethyl(phenyl)siloxy group, a dipropyl(phenyl)siloxy group, a trinaphthylsiloxy group, a hydroxydinaphthylsiloxy group, a methyldinaphthyl-siloxy group, an ethyldinaphthylsiloxy group, a propyldinaphthylsiloxy group, a dihy-droxy(naphthyl)siloxy group, a dimethyl(naphthyl)siloxy group, a diethyl(naphthyl)siloxy group, a dipropyl(naphthyl)siloxy group and the like.

In general formulae (1-1) and (1-2), at least one of L¹ or L² is preferably a group represented by general formula (2):

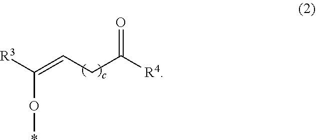

In general formula (2), R³ and R⁴ are each independently a hydrogen atom, a hydroxy group, a C₁₋₁₂ alkyl group, a C₅₋₁₂ alicyclic alkyl group, a C₁₋₁₂ alkoxy group, a C₆₋₁₂ aryl group, or a C₆₋₁₂ aryloxy group, and c is an integer of 0 to 2.

This structure is a structure derived from a diketone or a ketoester. This structure has keto-enol tautomerism. For convenience, general formula (2) is expressed in the form in which the enol unit structure is to be bound to M¹ or M² in the main chain of the polymetalloxane. However, this form has the same meaning as the form in which two oxygen atoms, as in a keto unit structure, are coordinated to M¹ and M² in the main chain of the polymetalloxane. Both expressions have no difference in the structure.

In the below-mentioned description, having a structure represented by general formula (2) in the side chain of a polymetalloxane is referred to as “having a diketone or ketoester structure in the side chain of a polymetalloxane,” in some examples.

In respect of the easiness with which a structure represented by general formula (2) is bound or coordinated to M¹ and M² in a polymetalloxane, c is preferably 0. That is, the structure of general formula (2) is preferably a β-diketone or a β-ketoester. Preferable specific examples of the structure are below-mentioned in the description of a method of producing a polymetalloxane.

Specific examples of the C₁₋₁₂ alkyl group in general formula (2) include a methyl group, an ethyl group, a propyl group, an isopropyl group, a butyl group, an isobutyl group, an s-butyl group, a t-butyl group, a pentyl group, a hexyl group, a heptyl group, an octyl group, a 2-ethylhexyl group, a nonyl group, a decyl group and the like.

Examples of the C₅₋₁₂ alicyclic alkyl group in general formula (2) include a cyclo-pentyl group, a cyclohexyl group, a cycloheptyl group, a cyclooctyl group, a cyclononyl group, a cyclodecyl group and the like.

Specific examples of the C₁₋₁₂ alkoxy group in general formula (2) include a methoxy group, an ethoxy group, a propoxy group, an isopropoxy group, a butoxy group, an isobutoxy group, an s-butoxy group, a t-butoxy group, a pentoxy group, a hexoxy group, a heptoxy group, an octoxy group, a 2-ethylhexoxy group, a nonyloxy group, a decyloxy group and the like.

Specific examples of the C₆₋₁₂ aryl group or C₆₋₁₂ aryloxy group in general formula (2) include a phenyl group, a phenoxy group, a benzyl group, a phenylethyl group, a naphthyl group and the like.

Among these, R¹ and R² are each preferably a C₁₋₄ alkyl group or a C₁₋₁₂ alkoxy group from the viewpoint of relaxation of the condensation stress of the polymetalloxane, the stress caused by heating.

M¹ and M² in general formulae (1-1) and (1-2) are preferably different metal atoms selected from the group consisting of Al, Ti, Y, Zr, Nb, and Sn. Containing these metal atoms makes it possible to obtain a polymetalloxane having a high refractive index.

In general formulae (1-1) and (1-2), m and n are each preferably 3 or greater and 5 or smaller.

A polymetalloxane according to an example is a polymetalloxane containing two or more kinds of metal atoms in the main chain.

Containing two or more metal atoms in the main chain makes it possible that, when a polymetalloxane according to an example is heated to be cured, the polymetalloxane is inhibited from crystal growth and crystal transition. Accordingly, the crack resistance of the resulting cured film is enhanced.

It is preferable for a polymetalloxane that, in general formulae (1-1) and (1-2), L¹ and L² are each a group represented by general formula (2), and that L¹ and L² are different from each other in R³ and/or R⁴ in each constituent unit. That L¹ and L² are different from each other in R³ and/or R⁴ in each constituent unit means that R³ in L¹ and R³ in L² are different, or that R⁴ in L¹ and R⁴ in L² are different, or that both thereof are different, and accordingly that L¹ and L² are not the same. We believe that using the same side chain with different kinds of metals preferentially advances the reaction between the metals having a high reactivity, causing the concern that the formable thickness of the cured film becomes small, or that the crystallization of the baked product tends to progress, decreasing the strength of the film.

In one specific example, a polymetalloxane is preferably a polymetalloxane in which M¹ is Zr, and M² is Al or Ti.

In particular, a polymetalloxane containing repeating constituent units in which M¹ and M² are represented by Zr and Al respectively is preferable. Curing such a polymetalloxane makes it possible to obtain a cured film having a high film density and a high heat resistance.

In addition, a polymetalloxane containing repeating constituent units in which M¹ and M² are represented by Zr and Ti respectively is preferable. Curing such a polymetalloxane makes it possible to obtain a cured film having a high refractive index.

In addition, a preferable specific example of a polymetalloxane preferably has, as a repeating constituent unit represented by general formula (1-1), a repeating constituent unit in which M¹ is Zr, L¹ is a group represented by general formula (2), and R³ and R⁴ are each a C₁₋₁₂ alkyl group. With Zr as M¹, the etching resistance of the resulting cured product and the thermal stability of the resulting baked product are excellent. In addition, the constituent unit, having the above-mentioned structure, results in a constituent unit having a high stability in moisture, contributing to the stability of the polymetalloxane.

In addition, the polymetalloxane preferably has, as a repeating unit represented by general formula (1-2), a repeating constituent unit in which M² is Al, L² is a group represented by general formula (2), and at least one of R³ and R⁴ is a C₁₋₁₂ alkoxy group. A compound having Al as M² has an excellent versatility. In addition, the constituent unit, having the above-mentioned structure, results in a constituent unit having a high stability in moisture, contributing to the stability of the polymetalloxane.

Furthermore, one of the particularly preferable specific examples is a polymetalloxane that contains, as a repeating constituent unit represented by general formula (1-1), a repeating constituent unit in which M¹ is Zr, L¹ is a group represented by general formula (2), and R³ and R⁴ are each a C₁₋₁₂ alkyl group, and that contains, as a repeating unit represented by general formula (1-2), a repeating constituent unit in which M² is Al, L² is a group represented by general formula (2), and at least one of R³ and R⁴ is a C₁₋₁₂ alkoxy group. Enhancing the stability of both constituent units contributes to the stability of the polymetalloxane.

The lower limit of the weight-average molecular weight of the polymetalloxane is preferably 30,000 or more, more preferably 100,000 or more. The upper limit of the weight-average molecular weight is preferably 5,000,000 or less, more preferably 3,000,000 or less, still more preferably 2,000,000 or less. Having a weight-average molecular weight within the above-mentioned ranges allows the polymetalloxane to have good coating characteristics. In addition, having a weight-average molecular weight equal to or greater than the lower limit value enhances the properties of the below-mentioned cured film, and affords a cured film having an excellent crack resistance in particular.

The weight-average molecular weight means a value measured by gel permeation chromatography (GPC) in terms of polystyrene. The weight-average molecular weight of the polymetalloxane can be determined by the following method. First, a polymetalloxane is dissolved at a concentration of 0.2 wt % in an eluent to obtain a sample solution. Subsequently, this sample solution is injected into a column packed with a porous gel and an eluent, and measured by gel permeation chromatography. The column eluate is detected by a differential refractive index detector, and the elution time is analyzed to determine the weight-average molecular weight of the polymetalloxane. An eluent to be selected is that which can dissolve a polymetalloxane at a concentration of 0.2 wt %. In particular, if a polymetalloxane is dissolved in an N-methyl-2-pyrrolidone solution containing lithium chloride at a concentration of 0.02 mol/dm³, this solution is used as an eluent.

A method of producing a polymetalloxane represented by general formulae (1-1) and (1-2) is subject to no particular limitation. It is possible to use the below-mentioned method.

### Method of Producing Polymetalloxane

A method of producing a polymetalloxane according to an example includes a step of polycondensing a compound represented by following general formula (3) or a hydrolysate of the compound (“compound represented by general formula (3) or the like”) to obtain a polymetalloxane having a weight-average molecular weight of 30,000 or more and 2,000,000 or less:

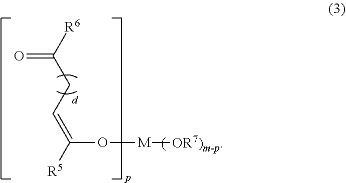

In general formula (3), R⁵ and R⁶ are each independently a hydrogen atom, a hydroxy group, a C₁₋₁₂ alkyl group, a C₅₋₁₂ alicyclic alkyl group, a C₁₋₁₂ alkoxy group, a C₆₋₁₂ aryl group, or a C₆₋₁₂ aryloxy group. R⁷ is a hydrogen atom, a C₁₋₁₂ alkyl group, or a group having a metalloxane bond. Specific examples of these substituents such as an alkyl group are the same as enumerated in the above description of general formula (2). When R⁵ to R⁷, two or more each, are present, the units may be the same or different.

M represents a metal atom selected from the group consisting of Al, Sc, Ti, V, Cr, Mn, Fe, Co, Ni, Cu, Zn, Ga, Ge, Y, Zr, Nb, Mo, In, Sn, Sb, Hf, Ta, W, and Bi. m is an integer that represents the valence of a metal atom M, p is an integer of 1 to (m−1), and d is an integer of 0 to 2.

A compound represented by general formula (3) can be obtained by allowing a metal alkoxide represented by general formula (4) to react with a compound represented by general formula (5) at a predetermined molar ratio so that a compound in which p is 1, 2, or 3 can be obtained:

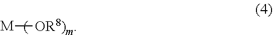

In general formula (4), R⁸ is a hydrogen atom or a C₁₋₁₂ alkyl group, and m is an integer that denotes the valence of a metal atom M.

When the metal atom M is Ti, examples of a metal alkoxide represented by general formula (4) include, but are not limited particularly to, tetramethoxy titanium, tetraethoxy titanium, tetrapropoxy titanium, tetraisopropoxy titanium, tetrabutoxy titanium, tetra-s-butoxy titanium, tetraisobutoxy titanium, tetra-t-butoxy titanium, tetrapentoxy titanium, tetrahexoxy titanium, tetraheptoxy titanium, tetraoctoxy titanium, tetranonyloxy titanium, tetradecyloxy titanium, tetracyclohexoxy titanium, tetraphenoxy titanium and the like.

When the metal atom M is Zr, examples of such a metal alkoxide include tetramethoxy zirconium, tetraethoxy zirconium, tetrapropoxy zirconium, tetraisopropoxy zirconium, tetrabutoxyzirconium, tetra-s-butoxy zirconium, tetraisobutoxy zirconium, tetra-t-butoxy zirconium, tetrapentoxy zirconium, tetrahexoxy zirconium, tetraheptoxy zirconium, tetraoctoxy zirconium, tetranonyloxy zirconium, tetradecyloxy zirconium, tetracyclohexoxy zirconium, tetraphenoxy zirconium and the like.

When the metal atom is Al, examples of such a metal alkoxide include trimethoxy aluminum, triethoxy aluminum, tri n-propoxy aluminum, triisopropoxy aluminum, tri-n-butoxy aluminum, tri-s-butoxy aluminum, s-butoxy(diisopropoxy) aluminum, triisobutoxy aluminum, tri-t-butoxy aluminum, tripentoxy aluminum, trihexoxy aluminum, triheptoxy aluminum, trioctoxy aluminum, trinonyloxy aluminum, tridecyloxy aluminum, tricyclohexoxy aluminum, triphenoxy aluminum and the like.

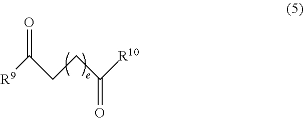

In general formula (5), R⁹ and R¹⁰ are each independently a hydrogen atom, a hydroxy group, a C₁₋₁₂ alkyl group, a C₅₋₁₂ alicyclic alkyl group, a C₁₋₁₂ alkoxy group, a C₆₋₁₂ aryl group, or a C₆₋₁₂ aryloxy group. e is an integer of 0 to 2.

When e=0, specific examples of a compound having a structure represented by general formula (5) include acetylacetone, 1,3 pentane dione, 2,4-pentane dione, 3,5-heptane dione, 1,3-hexane dione, 2,4-hexane dione, 3,5-hexane dione, 2,4-heptane dione, 3,5-heptane dione, 2,4-octane dione, 3,5-octane dione, dimethyl malonate, methylethyl malonate, diethyl malonate, methylbutyl malonate, ethylbutyl malonate, dibutyl malonate, diisobutyl malonate, t-butyl malonate, diisopropyl malonate, methylisopropyl malonate, ethylisopropyl malonate, butylisopropyl malonate, methyl acetoacetate, ethyl acetoacetate, propyl acetoacetate, butyl acetoacetate, isopropyl acetoacetate, isobutyl acetoacetate, t-butyl acetoacetate and the like. Among them, acetylacetone, methyl acetoacetate, and ethyl acetoacetate are used preferably.

When e=1, 2,5-hexane dione, 2,5-heptane dione, 2,5-octane dione, 3,6-octane dione, 3,6-nonane dione, dimethyl succinate, diethyl succinate, dibutyl succinate, diisobutyl succinate, t-butyl succinate, diisopropyl succinate, methylisopropyl succinate, ethylisopropyl succinate, butylisopropyl succinate and the like are used preferably.

When e=2, 2,6-heptane dione, 2,6-octane dione, dimethyl glutarate, diethyl glutarate, dibutyl glutarate, diisobutyl glutarate, t-butyl glutarate, diisopropyl glutarate, methylisopropyl glutarate, ethylisopropyl glutarate, butylisopropyl glutarate and the like are used preferably.

As a compound represented by general formula (5), two or more of the above-mentioned compounds may be used in combination.

Among them, a compound having a structure represented by general formula (6) is particularly preferable:

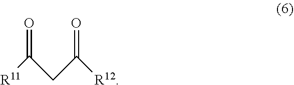

In general formula (6), R¹¹ and R¹² may be the same or different, and each independently represent a methyl group, an ethyl group, a propyl group, a butyl group, a phenyl group, a methoxy group, an ethoxy group, a propoxy group, or a butoxy group.

It is known that a compound having a diketone or ketoester structure forms a stable complex with one of various metal atoms. As with, for example, a compound having a structural unit represented by general formula (3), having, in a side chain, a molecule that forms a stable bond with a metal atom inhibits the elimination of a compound having a diketone or ketoester structure during the polycondensation of a metalloxane, and inhibits gelation during the polycondensation. In addition, having such a molecule in a side chain facilitates the solubility of the polymetalloxane in a solvent, enhancing the solubility in an all-purpose solvent and the solution stability.

In the reaction between the metal alkoxide represented by general formula (4) and the diketone compound represented by general formula (5), a solvent may be added to the reaction mixture, if needed. The reaction temperature is preferably 20 to 100° C., and the reaction time is preferably 10 to 120 minutes.

For the purpose of hydrolyzing the remaining alkoxide after the above-mentioned reaction, it is preferable that a necessary amount of water is added, the resulting solution is stirred, and a hydrolysis reaction is performed. If needed, alcohol generated is removed from the system. The reaction time is preferably 10 to 120 minutes.

For the purpose of producing a polymetalloxane represented by general formula (1) after the hydrolysis reaction is terminated, the temperature is raised in the range of from 60° C. to 180° C., and, if needed, a polymerization catalyst is added. Water of condensation and alcohol that have been generated are removed, and the polycondensation is advanced to obtain a polymetalloxane solution.

Examples of the solvent that can be used suitably include, but are not limited particularly to, an amide-based solvent, an ester-based solvent, an alcohol-based solvent, an ether-based solvent, a ketone-based solvent, dimethyl sulfoxide and the like.

Specific examples of the amide-based solvent include N,N-dimethylformamide, N,N-dimethylacetamide, N,N-dimethylisobutylamide, N-methyl-2-pyrrolidone, 1,3-dimethyl-2-imidazolidinone, N,N-dimethylpropyleneurea and the like.

Specific examples of the ester-based solvent include γ-butyrolactone, ethyl acetate, isobutyl acetate, propylene glycol monomethyl ether acetate, ethyl acetoacetate and the like.

Specific examples of the alcohol-based solvent include n-propanol, isopropanol, n-butanol, isobutanol, t-butanol, ethyl lactate, butyl lactate, propylene glycol monomethyl ether, diethylene glycol monomethyl ether, ethylene glycol, propylene glycol and the like.

Specific examples of the ether-based solvent include 1,2-dimethoxy ethane, 1,2-diethoxy ethane, dipropylene glycol dimethyl ether and the like.

Specific examples of the ketone-based solvent include diisobutylketone, acetylacetone, cyclopentanone, cyclohexanone and the like.

Examples of other solvents that can be preferably used include solvents described in WO2017/90512 and WO2019/188835.

A polymerization catalyst to be added, if desired, is subject to no particular limitation. An acidic catalyst or a basic catalyst is used preferably. Specific examples of the acidic catalyst include hydrochloric acid, nitric acid, sulfuric acid, hydrofluoric acid, phosphoric acid, acetic acid, trifluoroacetic acid, formic acid, polyvalent carboxylic acid or an anhydride thereof, and an ion exchange resin. Specific examples of the basic catalyst include triethylamine, tripropylamine, tributylamine, tripentylamine, trihexylamine, triheptylamine, trioctylamine, diethylamine, dipropylamine, dibutylamine, diisobutylamine, dipentylamine, dihexylamine, diheptylamine, dioctylamine, triethanolamine, diethanolamine, dicyclohexylamine, dicyclohexylmethylamine, sodium hydroxide, potassium hydroxide, an alkoxysilane having an amino group, and an ion exchange resin.

A more preferable polymerization catalyst is a basic catalyst. Using a basic catalyst makes it possible to obtain a high-molecular-weight polymetalloxane in particular. Among the basic catalysts, a particularly preferable catalyst is selected from diethylamine, dipropylamine, dibutylamine, dipentylamine, dihexylamine, diheptylamine, dioctylamine, triethylamine, tripropylamine, tributylamine, triisobutylamine, tripentylamine, trihexylamine, triheptylamine, trioctylamine, diethanolamine, triethanolamine, dicyclohexylamine, dicyclohexylmethylamine, and 2,2,6,6-tetramethylpiperidine.

The amount of the polymerization catalyst to be added is preferably 0.01 to 30 mol % with respect to 100 mol % of a compound represented by general formula (3).

In addition, from the viewpoint of the storage stability of the composition, the polymetalloxane solution after the hydrolysis, the partial condensation, and the polymerization preferably does not contain the above-mentioned polymerization catalyst. Accordingly, after the polymerization, the polymerization catalyst can be removed, if desired. A method for the removal is subject to no particular limitation. From the viewpoint of simple operation and removing performance, washing with water and/or a treatment with an ion exchange resin is/are preferable. Washing with water is a method in which a polymetalloxane solution is diluted with a suitable hydrophobic solvent, the resulting solution is then washed with water several times, and the resulting organic layer is concentrated with an evaporator or the like. A treatment with an ion exchange resin is a method in which a polymetalloxane solution is brought in contact with a suitable ion exchange resin.

### Composition Containing Polymetalloxane

A polymetalloxane according to an example can be mixed with a solvent or another desired component to be made into a composition. That is, a composition according to an example includes at least the above-described polymetalloxane.

When the polymetalloxane is made into a composition, the polymetalloxane is preferably diluted with a solvent so that the solid concentration can be adjusted. In this regard, the solid refers to a component other than a solvent in the composition. A solvent to be used for dilution is preferably, but not limited particularly to, the same solvent as used in the synthesis of a polymetalloxane. The solid concentration of the solution containing a polymetalloxane is preferably 0.1 to 50 wt %. Bringing the solid concentration within this range allows the film thickness to be well controlled when a coating film of the polymetalloxane is formed.

The solid concentration of the composition can be determined by weighing 1.0 g of the composition in an aluminum cup, heating the composition at 250° C. for 30 minutes using a hot plate to evaporate the liquid component, and weighing the solid component remaining in the aluminum cup after heating.

Another component may be added to this solution when the solid component of the polymetalloxane solution is adjusted. Examples of the another component include: a surfactant such as a fluorine-based surfactant or a silicone-based surfactant; a silane coupling agent; a cross-linking agent; a cross-linking accelerator; and the like. Specific examples of these components include the components described in WO2017/90512 and WO2019/188835.

### Cured Film, Baked Film, and Method of Producing Such Film

A cured film and a baked film according to an example are films cured by heating the above-mentioned polymetalloxane or polymetalloxane composition. In this regard, a film heated at less than 400° C. is referred to as a cured film, and a film heated at a temperature of 400° C. or more is referred to as a baked film. In a method of producing a cured film or a baked film according to an example, a cured film or a baked film can be obtained by coating a base plate with the above-mentioned polymetalloxane or a composition containing the polymetalloxane, and heating the coating. That is, this method of producing a cured film or a baked film includes a heating step of heating at least the polymetalloxane or a composition thereof. The cured film or baked film thus obtained are a cured film or a baked film mainly composed of a resin having, in the main chain, a metal atom having a high electron density so that the density of the metal atom in the film can be increased, thus making it possible to easily obtain a high refractive index. In addition, the cured film or baked film results in a dielectric containing no free electron, thus making it possible to obtain a high heat resistance.

Examples of the base plate to be coated with the polymetalloxane or a composition thereof include, but are not particularly limited to, a silicon wafer, a sapphire wafer, glass, an optical film and the like. Examples of the glass include alkali glass, alkali-free glass, thermally tempered glass, or chemically tempered glass. Examples of the optical film include a film made of an acrylic resin, a polyester resin, a polycarbonate, a polyallylate, a polyether sulfone, a polypropylene, a polyethylene, a polyimide, or a cycloolefin polymer.

Specifically, a method of producing a cured film or a baked film according to an example includes: a coating step of coating a base plate with the above-mentioned polymetalloxane or a composition thereof; and the above-mentioned heating step. In this coating step, a known method can be used as a coating method in which a base plate is coated with the polymetalloxane or a composition thereof. Examples of an apparatus used for coating include: full-surface coating apparatuses such as for spin coating, dip coating, curtain flow coating, spray coating, or slit coating; or printing apparatus such as for screen printing, roll coating, micro gravure coating, or ink jet.

In addition, after the base plate is coated with the polymetalloxane or a composition thereof in this coating step, the coating may be heated (prebaked) using a heating device such as a hot plate or an oven. Prebaking is preferably performed at a temperature in the range of 50° C. to 150° C. for 30 seconds to 30 minutes. The coating film prebaked is referred to as a prebaked film. Prebaking enables this prebaked film to have a good film thickness uniformity. The film thickness of this prebaked film is preferably 0.1 μm or more and 15 μm or less.

After the coating step is performed, the heating step of heating the polymetalloxane or a composition thereof on the base plate to obtain a cured film is performed. In this heating step, the coating film from the coating step or the prebaked film is preferably heated (cured) at a temperature in the range of 150° C. or more and less than 400° C. for 30 seconds to 2 hours using a heating device such as a hot plate or an oven. This makes it possible to obtain a cured film containing the polymetalloxane or a composition thereof. The film thickness of this cured film is preferably 0.1 μm or more and 15 μm or less. To obtain a baked film, heating is preferably performed in the same manner at a temperature in the range of 400° C. or more. The baking temperature is more preferably 400° C. or more and 2000° C. or less, still more preferably 500° C. or more and 1500° C. or less.

The cured film or the baked film thus obtained preferably has a refractive index of 1.53 or more and 2.20 or less at a wavelength of 550 nm, and the refractive index is more preferably 1.65 or more and 2.10 or less.

The refractive index of the cured film or the baked film can be measured by the below-mentioned method. For example, in this method of measuring a refractive index, a spectroscopic ellipsometer is used to measure a change in the state of polarization of a reflected light from each of a cured film or a baked film and a base plate, and a phase difference from the incident light and a spectrum of amplitude reflectance are obtained. A refractive index spectrum is obtained by fitting a dielectric function of a computation model closer to the spectrum obtained. Reading a refractive index value at a wavelength of 550 nm from the refractive index spectrum obtained makes it possible to obtain the refractive index of the cured film or the baked film.

### Applications of Cured Film and Baked Film

A cured film and a baked film according to an example have an excellent refract-tive index and insulating properties, and thus, are suitably used for a member of an electronic component such as a solid image pickup device or a display. The member refers to one of the parts used to assemble an electronic component. That is, a member according to an example includes a cured film or a baked film containing the above-described polymetalloxane or a composition thereof. An electronic component according to an example includes such a cured film or a baked film. Examples of members for solid image pickup devices include condensing lenses, light guides for connecting a condensing lens and a photosensor unit, antireflection films, and the like. Examples of members for displays include index matching materials, planarizing materials, insulation protecting materials, and the like.

In addition, a cured film or a baked film according to an example can also be used as a protective film in a multilayer NAND flash memory, a dry etching resist, a buffer coat in a semiconductor device, an interlayer insulating film, and one of various protective films.

### Ceramic Film

A ceramic film according to an example is a ceramic film containing two or more metals, and is an oxide ceramic film, wherein at least one of the metals is Zr, the ratio of Zr in the metal elements is 5 to 70 mol %, and the largest peak intensity of the Zr crystal in the range of 30.1<20<30.3 is 15,000 counts/mol % or less.

A ceramic film according to an example can be obtained by heating the above-mentioned polymetalloxane or polymetalloxane composition at a temperature of 400° C. or more. During this, the ceramic film, if allowed to undergo excessive crystal growth, tends to cause a crack. In addition, even when no crack is caused, using the film as a dry etching resist has an undesirable possibility of causing an ununiform etching resistance, and thus is not preferable. Using, as the polymetalloxane, a polymetalloxane having a structure represented by general formula (2) makes it possible to decrease the crystal growth of a metal oxide in the baked product. Examples of a technique for determining the degree of crystallization include using an X-ray diffractometer to measure the ceramic film in powdered form. When this is done, the crystal peak assumed to be derived from the tetragonal crystal of Zr is observed at 30.1<20<30.3. Thus, a value obtained by dividing the intensity of this peak by the ratio of Zr in the metal elements is calculated as the largest peak intensity of the Zr crystal. For example, when the intensity of the crystallization peak measured is 5,000 counts, and in which the ratio of Zr in the metal elements is 20 mol %, the peak intensity of the Zr crystal is 10,000 counts/mol %. In this regard, the ratio of Zr in the metal elements can be determined by measuring a ceramic film in powdered form by ICP analysis. In this regard, to make the measurement error small, it is preferable that the ceramic film in powdered form is further baked at 700° C. for 30 minutes, and the resulting film is used for measurement with an X-ray diffractometer.

### Fiber Applications

A polymetalloxane according to an example or a composition thereof can be formed into a fiber by spinning. That is, a fiber according to an example contains the above-mentioned polymetalloxane or contains a composition of the polymetalloxane. Baking a fiber thus obtained makes it possible to obtain a metal oxide fiber.

A fiber composed of a metal oxide has properties such as a high heat resistance, a high strength, and a surface activity, and is promisingly expected to have properties useful for various applications. Such a fiber (metal oxide fiber) is produced commonly by a melt-fiberizing method. This method is as follows. In this method, for example, a metal oxide raw material and a compound having a low melting point such as silica, are first mixed. Next, this mixture is melted in a high-temperature furnace, and then, the melt is taken out as a thin stream. High-pressure air is blown against the thin stream, or a centrifugal force is applied thereto, whereby the stream is rapidly cooled to form a metal oxide fiber. In the melt-fiberizing method, however, the metal oxide raw material at a higher concentration involves a higher melting temperature, thus making it difficult to obtain a metal oxide fiber having a high concentration of metal oxide (a fiber having a high concentration of metal oxide, as appropriate).

In a generally known method of obtaining a fiber having a high concentration of metal oxide, a spinning solution containing a metal oxide raw material and a thickener is used to produce a fibrous precursor, which is spun by heating. However, such a method has a problem in that the thickener, when burned off in a baking process, generates pores and cracks, resulting in causing the resulting metal oxide fiber to have an insufficient strength.

A polymetalloxane according to an example or a composition thereof can be treated in the form of a solution, and thus, can be spun without undergoing such a melting step as performed in the above-mentioned melt-fiberizing method. In addition, the polymetalloxane or a composition thereof, when spun, is treated without a thickener, thus making it possible to obtain a dense metal oxide fiber. Thus, it is made possible to easily obtain a metal oxide fiber having characteristics such as a high heat resistance, a high strength, and a surface activity.

### Method of Producing Fiber

A method of producing a fiber according to an example includes at least a spinning step of spinning the above-mentioned polymetalloxane or a composition thereof to obtain a fiber. In this spinning step, a known method can be used as the method of spinning a solution of the polymetalloxane or a composition thereof. Examples of this spinning method include a dry spinning method, a wet spinning method, a dry-wet spinning method, an electrospinning method and the like. Hereinafter, the “polymetalloxane or a composition thereof” is referred to as the “composition or the like,” as appropriate.

The dry spinning method is a method in which the composition or the like is extruded under a load into an atmosphere through spinnerets having pores, and the organic solvent is evaporated to obtain a thread product. In this method, the composition or the like may be heated to be decreased in viscosity when extruded. In addition, the composition or the like may be extruded into a heated atmosphere with the evaporation rate of the organic solvent controlled. It is also possible that, after the composition or the like is extruded, the thread product is stretched using a rotating roller or a high-speed air flow.

The wet spinning is a method in which the composition or the like is extruded under a load into a coagulation bath through spinnerets having pores, and the organic solvent is removed to obtain a thread product. A coagulation bath to be preferably used is water or a polar solvent. In addition, the dry-wet spinning is a method in which the composition or the like is extruded into an atmosphere, and then immersed in a coagulation bath, and the organic solvent is removed to obtain a thread product.

The electrospinning method is a method in which a high voltage is applied to a nozzle packed with the composition or the like, and electric charges are thereby gathered in liquid droplets at the tip of the nozzle, and repel each other to spread the droplets, whereby the solution stream is stretched to be spun. This method makes it possible to obtain a thread product having a small diameter. Accordingly, using an electrospinning method makes it possible to obtain a thin thread product having a diameter of tens of nanometers to several micrometers.

Among these, in particular, a dry spinning method or an electrospinning method can be preferably used as a spinning method in the spinning step.

In the spinning step, a fiber obtained by spinning may undergo, if desired, a dry-ing treatment, a steam treatment, a hot-water treatment, or a combination of these treatments before undergoing baking.

Baking a fiber obtained by spinning in the above-mentioned spinning step makes it possible that the cross-linking reaction progresses, and in addition, organic components such as organic groups are removed, whereby a metal oxide fiber having an excellent strength is obtained. That is, a method of producing a metal compound fiber according to an example includes the above-mentioned spinning step and the baking step of baking a fiber obtained in the spinning step. In this baking step, the baking temperature is subject to no particular limitation, and is preferably 400° C. or more and 2000° C. or less, still more preferably 500° C. or more and 1500° C. or less. The baking method is subject to no particular limitation. Examples of the baking method include a method of baking in an air atmosphere, a method of baking in an inert atmosphere such as nitrogen or argon, a method of baking in vacuum and the like.

In addition, in the baking step, the resulting metal oxide fiber may be further baked in a reducing atmosphere such as hydrogen. In the baking step, a fiber or a metal oxide fiber, which is obtained by spinning, may be baked with tension applied thereto.

Such a method makes it possible to obtain a continuous and dense metal oxide fiber having an average fiber diameter of 0.01 μm or more and 1000 μm or less. The metal oxide fiber preferably has an average fiber diameter of 0.01 μm or more and 1000 μm or less, still more preferably 0.10 μm or more and 200 μm or less. The average fiber diameter within the range enables the metal oxide fiber to be a crackless and homogeneous fiber.

The average fiber diameter of the resulting metal oxide fiber is determined by the following method. For example, an adhesive tape is bonded to a piece of backing paper. To the resulting piece, a single fiber the fiber diameter of which is to be measured is bonded horizontally to obtain a single fiber test piece. The upper face of this single fiber test piece is observed under an electron microscope, and the width of the image is regarded as the fiber diameter. Three measurements are taken along the length direction, and the average of the measurement values is regarded as the fiber diameter. This operation is performed on 20 single fibers selected randomly. The fiber diameters obtained are averaged to afford an average fiber diameter.

In addition, the metal oxide fiber, if allowed to undergo excessive crystal growth, will cause concern about a decrease in the strength of the fiber, and thus, is not preferable. When a solution of a polymetalloxane according to an example or a composition thereof is spun, and in which the fiber obtained by this spinning is then baked to obtain a metal oxide fiber, use of a polymetalloxane having a structure represented by general formula (2) makes it possible to decrease the crystal growth of the metal oxide fiber obtained.

The fiber, such as a metal oxide fiber, obtained by spinning a solution of a polymetalloxane according to an example or a composition thereof and baking the fiber obtained by this spinning can be utilized as a photocatalyst, a heat-insulating material, a heat-radiating material, or a composite material such as a fiber-reinforced plastic (FRP). For example, as a photocatalyst, such a fiber can be used, for example, for a filter for purification of water or the air. As a heat-insulating material or a heat-radiating material, such a fiber can be used for an electric furnace, a nuclear fuel rod sheath, an engine turbine of an aircraft, a heat exchanger or the like.

### Multinary Copolymerized Polymetalloxane

A polymetalloxane, even if having one kind of metal, achieves an excellent heat resistance, chemical resistance and the like. For example, a polymetalloxane containing Zr as the one kind of metal has an excellent heat resistance and chemical resistance. On the other hand, a polymetalloxane having one kind of metal has a problem in that such a polymetalloxane, when made into a cured film, tends to cause a crack, and in addition, that such a polymetalloxane, when made into a fiber, is not allowed to be spun stably.

In view of this, for the purpose of solving these problems, a multinary polymetalloxane containing Zr as the M¹ and Al, Ti, or the like as the M² was studied. As a result, the number of cracks observed was small when M¹ was Zr, and M² was Al, and in which a crack resistance was evaluated, as below-mentioned, with a cured film produced from a polymetalloxane composition at a molar ratio in the range of Zr:Al=1:9 to 9:1. In addition, using such a polymetalloxane composition possibly makes stable spinning possible. In the same manner, it was discovered that, also when M¹ was Zr, and M² was Ti, the cured film had no crack at a molar ratio in the range of Zr:Ti=1:9 to 9:1, and stable spinning was possible. The range is more preferably Zr:Al or Ti=1:9 to 7:3. The Zr, if too much, will cause a crack in the cured film, and make stable spinning more difficult. In addition, the Zr, if smaller than 1:9, will cause a decrease in the heat resistance and the chemical resistance.

### Examples

Our polymetalloxanes, compositions, films and methods will now be described more specifically by way of Examples, but this disclosure is not limited to the Examples.

### Infrared Spectroscopic Analysis

Analysis by Fourier transform infrared spectroscopy (hereinafter referred to as FT-IR) was performed by the following method. First, using a Fourier transform infrared spectrometer (FT720, manufactured by Shimadzu Corporation), two silicon wafers superposed one upon the other were measured, and the measurement result was used as a baseline. Next, one drop of a metal compound or a solution thereof was dropped on the silicon wafer, and sandwiched between the silicon wafer and another silicon wafer, whereby a measurement sample was obtained. An absorbance of the compound or a solution thereof was calculated from the difference between the absorbance of the measurement sample and the absorbance of the baseline, and the absorption peak was read.

### Measurement of Weight-Average Molecular Weight

The weight-average molecular weight (Mw) was determined by the following method. Lithium chloride was dissolved in N-methyl-2-pyrrolidone to prepare a 0.02 mol/dm³ lithium chloride/N-methyl-2-pyrrolidone solution as an eluent. A polymetalloxane was dissolved at 0.2 wt % in the eluent, and the solution thus obtained was used as a sample solution. A porous gel column (TSK gel α-M and α-3000, one each, manufactured by Tosoh Corporation) was packed with the eluent at a flow rate of 0.5 mL/min. Into the column, 0.2 mL of the sample solution was injected, and measured by gel permeation chromatography. The eluate from the column was detected by a differential refractive index detector (Model RI-201, manufactured by Showa Denko K.K.), and the elution time was analyzed to determine the weight-average molecular weight (Mw) in terms of polystyrene.

### MATERIALS USED IN EXAMPLES AND COMPARATIVE EXAMPLES

### Synthesis Example 1: Synthesis of Zirconium Compound (M-1)

Into a three-necked flask having a capacity of 500 ml, 32.8 g (0.1 mol) of tetrapropoxyzirconium was fed, and the flask was immersed in an oil bath at 40° C. The resulting mixture was stirred for 30 minutes. Thereafter, using a dropping funnel, 10.0 g (0.1 mol) of acetylacetone was added over a period of 1 hour and, after the addition, the mixture was stirred for additional 1 hour. The contents of the flask were transferred to a 200 ml recovery flask, and propanol thus formed was distilled off under reduced pressure to obtain a yellow liquid zirconium compound (M-1).

This zirconium compound (M-1) was analyzed by FT-IR. An absorption peak of C═O (1595 cm⁻¹) and an absorption peak of C═C (1532 cm⁻¹), which were derived from the formation of a chelate ring with the acetylacetone, were observed, but an absorption peak of C═O (1725 cm⁻¹) derived from the acetylacetone before reaction was not observed, thus verifying that the zirconium compound (M-1) obtained was zirconium tri-n-propoxymonoacetylacetonate.

### Synthesis Example 2: Synthesis of Zirconium Compound (M-2)

Into a three-necked flask having a capacity of 500 ml, 32.8 g (0.1 mol) of tetrapropoxyzirconium was fed, and the flask was immersed in an oil bath at 40° C. The resulting mixture was stirred for 30 minutes. Thereafter, using a dropping funnel, 9.0 g (0.1 mol) of trimethylsilanol was added over a period of 1 hour and, after the addition, the mixture was stirred for additional 1 hour. The contents of the flask were transferred to a 200 ml recovery flask, and propanol thus formed was distilled off under reduced pressure to obtain a colorless liquid zirconium compound (M-2).

This zirconium compound (M-2) was analyzed by FT-IR. An absorption peak of Zr—O—Si (968 cm⁻¹) was observed, but an absorption of silanol (883 cm⁻¹) did not exist, thus verifying that the zirconium compound (M-2) obtained was tri-n-propoxy(trimethylsiloxy)zirconium.

### Synthesis Example 3: Aluminum Compound (M-3)

Into a three-necked flask having a capacity of 500 ml, 24.6 g (0.1 mol) of tri-s-butoxyaluminum was fed, and the flask was immersed in an oil bath at 40° C. The resulting mixture was stirred for 30 minutes. Thereafter, using a dropping funnel, 13.0 g (0.1 mol) of ethyl acetoacetate was added over a period of 1 hour and, after the addition, the mixture was stirred for additional 1 hour. The contents of the flask were transferred to a 200 ml recovery flask, and isopropanol thus formed was distilled off under reduced pressure to obtain a yellow liquid aluminum compound (M-3).

This aluminum compound (M-3) was analyzed by FT-IR. An absorption peak of C═O (1600 cm⁻¹) and an absorption peak of C═C (1530 cm⁻¹), which were derived from the formation of a chelate ring with the ethyl acetoacetate, were observed, but an absorption peak of C═O (1712 cm⁻¹) derived from the ethyl acetoacetate before reaction was not observed, thus verifying that the aluminum compound (M-3) obtained was aluminum di-s-butoxymonoethylacetoacetate.

### Synthesis Example 4: Synthesis of Aluminum Compound (M-4)

Into a three-necked flask having a capacity of 500 ml, 24.6 g (0.1 mol) of tri-s-butoxyaluminum was fed, and the flask was immersed in an oil bath at 40° C. The resulting mixture was stirred for 30 minutes. Thereafter, using a dropping funnel, 9.0 g (0.1 mol) of trimethylsilanol was added over a period of 1 hour and, after the addition, the mixture was stirred for additional 1 hour. The contents of the flask were transferred to a 200 ml recovery flask, and isopropanol thus formed was distilled off under reduced pressure to obtain a colorless liquid aluminum compound (M-4).

This aluminum compound (M-4) was analyzed by FT-IR. An absorption peak of Al—O—Si (949 cm⁻¹) was observed, but an absorption of silanol (883 cm⁻¹) did not exist, thus verifying that the aluminum compound (M-4) obtained was di-s-butoxy(trimethylsiloxy)aluminum.

### Synthesis Example 5: Synthesis of Titanium Compound (M-5)

In a three-necked flask having a capacity of 500 ml, 34.0 g (0.1 mol) of tetrabutoxytitanium was fed, and the flask was immersed in an oil bath at 40° C. The resulting mixture was stirred for 30 minutes. Thereafter, using a dropping funnel, 10.0 g (0.1 mol) of acetylacetone was added over a period of 1 hour and, after the addition, the mixture was stirred for additional 1 hour. The contents of the flask were transferred to a 200 ml recovery flask, and butanol thus formed was distilled off under reduced pressure to obtain a colorless liquid titanium compound (M-5).

This titanium compound (M-5) was analyzed by FT-IR. An absorption peak of C═O (1595 cm⁻¹) and an absorption peak of C═C (1532 cm⁻¹), which were derived from the formation of a chelate ring with the acetylacetone, were observed, but an absorption peak of C═O (1725 cm⁻¹) derived from the acetylacetone before reaction was not observed, thus verifying that the titanium compound (M-5) obtained was titanium tri-n-butoxymonoacetylacetonate.

### Synthesis Example 6: Synthesis of Titanium Compound (M-6)

Into a three-necked flask having a capacity of 500 ml, 34.0 g (0.1 mol) of tetrabutoxytitanium was fed, and the flask was immersed in an oil bath at 40° C. The resulting mixture was stirred for 30 minutes. Thereafter, using a dropping funnel, 9.0 g (0.1 mol) of trimethylsilanol was added over a period of 1 hour and, after the addition, the mixture was stirred for additional 1 hour. The contents of the flask were transferred to a 200 ml recovery flask, and butanol thus formed was distilled off under reduced pressure to obtain a colorless liquid titanium compound (M-6).

This titanium compound (M-6) was analyzed by FT-IR. An absorption peak of Ti—O—Si (958 cm⁻¹) was observed, but an absorption of silanol (883 cm⁻¹) did not exist, thus verifying that the titanium compound (M-6) obtained was tributoxy(trimethylsiloxy)titanium.

TABLE 1

| | | Raw Material 1 | Raw Material 2 |
|---|---|---|---|
| Synthesis Example 1 | Zirconium Compound (M-1) | 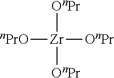 | 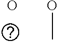 |
| Synthesis Example 2 | Zirconium Compound (M-2) | 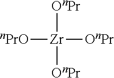 | 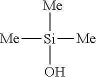 |
| Synthesis Example 3 | Aluminum Compound (M-3) | 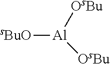 | 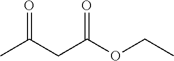 |
| Synthesis Example 4 | Aluminum Compound (M-4) | 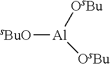 | 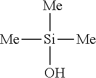 |
| Synthesis Example 5 | Titanium Compound (M-5) | 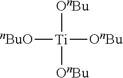 | 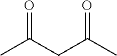 |
| Synthesis Example 6 | Titanium Compound (M-6) | 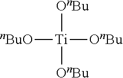 | 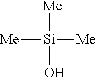 |
| Synthesis Example 23 | Zirconium Compound (M-7) | 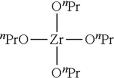 | 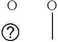 |
| | | Metal Compound Obtained | Deduced Structure |
| | Synthesis Example 1 | Zirconium tri-n- propoxymonoacetylacetonate | 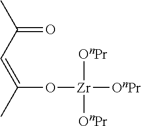 |
| | Synthesis Example 2 | Tri-n-propoxy(trimethyl- siloxy)zirconium | 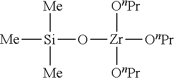 |
| | Synthesis Example 3 | Aluminum di-s- butoxymonoethylacetoacetate | 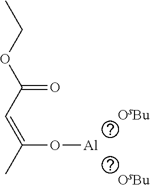 |
| | Synthesis Example 4 | Di-s-butoxy(trimethyl- siloxy)aluminum | 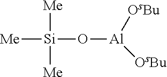 |
| | Synthesis Example 5 | Titanium tri-n- butoxymonoacetylacetonate | 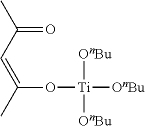 |
| | Synthesis Example 6 | Tri-n-butoxy(trimethyl- siloxy)titanium | 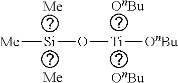 |
| | Synthesis Example 23 | Zirconium tri-n- propoxymonoethylacetoacetate | 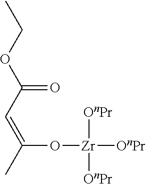 |

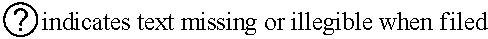

### Polymetalloxane

### Synthesis Example 7: Polymetalloxane (A-1)

Zirconium tri-n-propoxymonoacetylacetonate in an amount of 3.68 g (0.01 mol), 27.21 g (0.09 mol) of aluminum di-s-butoxymonoethylacetoacetate, and 30.00 g of N,N-dimethylisobutylamide (DMIB) as a solvent were mixed to obtain a solution 1. In addition, 3.78 g (0.21 mol) of water, 50.0 g of isopropanol (IPA) as a water-diluting solvent, and 1.85 g (0.01 mol) of tributylamine as a polymerization catalyst were mixed to obtain a solution 2.

Into a three-necked flask having a capacity of 500 ml, the entire amount of the solution 1 was fed, and the flask was immersed in an oil bath at 40° C. The solution was stirred for 30 minutes. Thereafter, the entire amount of the solution 2 was fed into a dropping funnel for the purpose of hydrolysis, and then added in the flask over a period of 1 hour. During the addition of the solution 2, precipitation did not occur in the contents of the flask, and the solution was uniformly yellow and transparent. After the addition, the mixture was stirred for additional 1 hour to obtain a hydroxy-group-containing metal compound. Thereafter, for the purpose of polycondensation, the oil bath was heated to 140° C. over a period of 30 minutes. One hour after the temperature started rising, the internal temperature of the reaction solution reached 100° C. and, then, the mixture was heated with stirring for 2 hours (the internal temperature was 100 to 130° C.). During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly yellow and transparent. The solid concentration of the polymetalloxane solution obtained was determined, and then, DMIB was added such that the solid concentration became 25 wt %, to obtain a polymetalloxane (A-1) solution. The polymetalloxane (A-1) contains structural units represented by general formulae (1-1) and (1-2), M¹ is Zr, M² is Al, L¹ and L² are both groups represented by general formula (2), m is 4, a is 1, n is 3, b is 1, and R¹ is an n-propyl group. In L¹, R³ is a methyl group, R⁴ is a methyl group, and c is 0. In L², R³ is a methyl group, R⁴ is an ethoxy group, and c is 0. The weight-average molecular weight (Mw) of the polymetalloxane (A-1) was 1,120,000 in terms of polystyrene.

### Synthesis Example 8: Polymetalloxane (A-2)

Zirconium tri-n-propoxymonoacetylacetonate in an amount of 14.70 g (0.04 mol), 18.14 g (0.06 mol) of aluminum di-s-butoxymonoethylacetoacetate, and 30.00 g of DMIB as a solvent were mixed to obtain a solution 1. In addition, 4.32 g (0.24 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly yellow and transparent. The solid concentration of the polymetalloxane solution obtained was determined, and then, DMIB was added such that the solid concentration became 25 wt %, to obtain a polymetalloxane (A-2) solution. The weight-average molecular weight (Mw) of the polymetalloxane (A-2) was 1,230,000 in terms of polystyrene.

### Synthesis Example 9: Polymetalloxane (A-3)

Zirconium tri-n-propoxymonoacetylacetonate in an amount of 22.06 g (0.06 mol), 12.09 g (0.04 mol) of aluminum di-s-butoxymonoethylacetoacetate, and 30.00 g of DMIB as a solvent were mixed to obtain a solution 1. In addition, 4.69 g (0.26 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly yellow and transparent. The solid concentration of the polymetalloxane solution obtained was determined, and then, DMIB was added such that the solid concentration became 25 wt %, to obtain a polymetalloxane (A-3) solution. The weight-average molecular weight (Mw) of the polymetalloxane (A-3) was 1,300,000 in terms of polystyrene.

### Synthesis Example 10: Polymetalloxane (A-4)

Zirconium tri-n-propoxymonoacetylacetonate in an amount of 33.08 g (0.09 mol), 3.02 g (0.01 mol) of aluminum di-s-butoxymonoethylacetoacetate, and 30.00 g of DMIB as a solvent were mixed to obtain a solution 1. In addition, 5.23 g (0.29 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly yellow and transparent. The solid concentration of the polymetalloxane solution obtained was determined and, then, DMIB was added such that the solid concentration became 25 wt %, to obtain a polymetalloxane (A-4) solution. The weight-average molecular weight (Mw) of the polymetalloxane (A-4) was 1,340,000 in terms of polystyrene.

### Synthesis Example 11: Polymetalloxane (A-5)

Zirconium tri-n-propoxymonoacetylacetonate in an amount of 14.70 g (0.04 mol), 15.74 g (0.06 mol) of di-s-butoxy(trimethylsiloxy)aluminum, and 30.00 g of DMIB as a solvent were mixed to obtain a solution 1. In addition, 4.32 g (0.24 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly yellow and transparent. The solid concentration of the polymetalloxane solution obtained was determined and, then, DMIB was added such that the solid concentration became 25 wt %, to obtain a polymetalloxane (A-5) solution. The weight-average molecular weight (Mw) of the polymetalloxane (A-5) was 860,000 in terms of polystyrene.

### Synthesis Example 12: Polymetalloxane (A-6)

Tri-n-propoxy(trimethylsiloxy)zirconium in an amount of 14.31 g (0.04 mol), 18.14 g (0.06 mol) of aluminum di-s-butoxymonoethylacetoacetate, and 30.00 g of DMIB as a solvent were mixed to obtain a solution 1. In addition, 4.32 g (0.24 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly yellow and transparent. The solid concentration of the polymetalloxane solution obtained was determined and, then, DMIB was added such that the solid concentration became 25 wt %, to obtain a polymetalloxane (A-6) solution. The weight-average molecular weight (Mw) of the polymetalloxane (A-6) was 720,000 in terms of polystyrene.

### Synthesis Example 13: Polymetalloxane (A-7)

Zirconium tri-n-propoxymonoacetylacetonate in an amount of 3.68 g (0.01 mol), 32.97 g (0.09 mol) of titanium tri-n-butoxymonoacetylacetonate, and 30.00 g of DMIB as a solvent were mixed to obtain a solution 1. In addition, 5.41 g (0.30 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly orange and transparent. The solid concentration of the polymetalloxane solution obtained was determined and, then, DMIB was added such that the solid concentration became 25 wt %, to obtain a polymetalloxane (A-7) solution. The weight-average molecular weight (Mw) of the polymetalloxane (A-7) was 1,240,000 in terms of polystyrene.

### Synthesis Example 14: Polymetalloxane (A-8)

Zirconium tri-n-propoxymonoacetylacetonate in an amount of 14.70 g (0.04 mol), 21.98 g (0.06 mol) of titanium tri-n-butoxymonoacetylacetonate, and 30.00 g of DMIB as a solvent were mixed to obtain a solution 1. In addition, 5.41 g (0.30 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly orange and transparent. The solid concentration of the polymetalloxane solution obtained was determined and, then, DMIB was added such that the solid concentration became 25 wt %, to obtain a polymetalloxane (A-8) solution. The weight-average molecular weight (Mw) of the polymetalloxane (A-8) was 1,310,000 in terms of polystyrene.

### Synthesis Example 15: Polymetalloxane (A-9)

Zirconium tri-n-propoxymonoacetylacetonate in an amount of 22.06 g (0.06 mol), 14.65 g (0.04 mol) of titanium tri-n-butoxymonoacetylacetonate, and 30.00 g of DMIB as a solvent were mixed to obtain a solution 1. In addition, 5.41 g (0.30 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly orange and transparent. The solid concentration of the polymetalloxane solution obtained was determined and, then, DMIB was added such that the solid concentration became 25 wt %, to obtain a polymetalloxane (A-9) solution. The weight-average molecular weight (Mw) of the polymetalloxane (A-9) was 1,360,000 in terms of polystyrene.

### Synthesis Example 16: Polymetalloxane (A-10)

Zirconium tri-n-propoxymonoacetylacetonate in an amount of 33.08 g (0.09 mol), 3.66 g (0.01 mol) of titanium tri-n-butoxymonoacetylacetonate, and 30.00 g of DMIB as a solvent were mixed to obtain a solution 1. In addition, 5.41 g (0.30 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly orange and transparent. The solid concentration of the polymetalloxane solution obtained was determined and, then, DMIB was added such that the solid concentration became 25 wt %, to obtain a polymetalloxane (A-10) solution. The weight-average molecular weight (Mw) of the polymetalloxane (A-10) was 1,410,000 in terms of polystyrene.

### Synthesis Example 17: Polymetalloxane (A-11)

Zirconium tri-n-propoxymonoacetylacetonate in an amount of 14.70 g (0.04 mol), 21.38 g (0.06 mol) of tri-n-butoxy(trimethylsiloxy)titanium, and 30.00 g of DMIB as a solvent were mixed to obtain a solution 1. In addition, 5.41 g (0.30 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly yellow and transparent. The solid concentration of the polymetalloxane solution obtained was determined and, then, DMIB was added such that the solid concentration became 25 wt %, to obtain a polymetalloxane (A-11) solution. The weight-average molecular weight (Mw) of the polymetalloxane (A-11) was 1,110,000 in terms of polystyrene.

### Synthesis Example 18: Polymetalloxane (A-12)

Tri-n-propoxy(trimethylsiloxy)zirconium in an amount of 14.31 g (0.04 mol), 21.98 g (0.06 mol) of titanium tri-n-butoxymonoacetylacetonate, and 30.00 g of DMIB as a solvent were mixed to obtain a solution 1. In addition, 5.41 g (0.30 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly orange and transparent. The solid concentration of the polymetalloxane solution obtained was determined and, then, DMIB was added such that the solid concentration became 25 wt %, to obtain a polymetalloxane (A-12) solution. The weight-average molecular weight (Mw) of the polymetalloxane (A-12) was 1,090,000 in terms of polystyrene.

### Synthesis Example 19: Polymetalloxane (A-13)

Tri-n-propoxy(trimethylsiloxy)zirconium in an amount of 14.31 g (0.04 mol), 15.74 g (0.06 mol) of di-s-butoxy(trimethylsiloxy)aluminum, and 30.00 g of DMIB as a solvent were mixed to obtain a solution 1. In addition, 4.32 g (0.24 mol) of water, 50.0 g of IPA as a water-diluting solvent, and 1.85 g (0.01 mol) of tributylamine as a polymerization catalyst were mixed to obtain a solution 2.

Hydrolysis and polycondensation were performed the same as in Synthesis Example 7. During the reaction, IPA, n-propanol, 2-butanol, and water were distilled off. During the heating with stirring, precipitation did not occur in the contents of the flask, and the solution was uniformly transparent.

After completion of the heating, the contents of the flask were cooled to room temperature to obtain a polymetalloxane solution. The polymetalloxane solution obtained was uniformly orange and transparent. The solid concentration of the polymetalloxane solution obtained was determined and, then, DMIB was added such that the solid concentration became 25 wt %, to obtain a polymetalloxane (A-13) solution. The weight-average molecular weight (Mw) of the polymetalloxane (A-13) was 500,000 in terms of polystyrene.

### Synthesis Example 20: Polymetalloxane (A-14)

Into a three-necked flask having a capacity of 500 ml, 34.03 g (0.10 mol) of tetrabutoxytitanium was fed, and the flask was immersed in an oil bath at 75° C. The resulting mixture was stirred for 30 minutes. Thereafter, for the purpose of hydrolysis, a solution mixture of 3.06 g (0.17 mol) of water and 50 g of n-butanol was fed into a dropping funnel and, then, added in the flask over a period of 1 hour. Thereafter, for the purpose of polycondensation, the oil bath was heated to 90° C. over a period of 30 minutes. The resulting mixture was held with stirring for 1 hour to allow the reaction to age.

After completion of the heating, the contents of the flask were cooled to room temperature and transferred to a 200 ml recovery flask, and butanol thus formed was distilled off under reduced pressure to obtain a white solid polymetalloxane. To the polymetalloxane obtained, DMIB was added such that the solid concentration became 25 wt %, to obtain a polymetalloxane (A-14) solution. The weight-average molecular weight (Mw) of the polymetalloxane (A-14) was 1,700 in terms of polystyrene.

### Synthesis Example 21: Polymetalloxane (A-15)

In the same manner as in Synthesis Example 8, the solution 2 was added to the solution 1 to obtain a hydroxy-group-containing metal compound that was a uniform transparent solution. Thereafter, for the purpose of polycondensation, the oil bath was heated to 90° C. over a period of 30 minutes. The resulting mixture was stirred under heating for 1 hour. After completion of the heating, the contents of the flask were transferred to a recovery flask. Using an evaporator, the solvent was removed. Thus, a polymetalloxane solution was obtained. The polymetalloxane solution obtained was uniformly yellow and transparent. The solid concentration of the polymetalloxane solution obtained was determined and, then, DMIB was added such that the solid concentration became 25 wt %, to obtain a polymetalloxane (A-15) solution. The weight-average molecular weight (Mw) of the polymetalloxane (A-15) was 26,000 in terms of polystyrene.

### Synthesis Example 22: Polymetalloxane (A-16)

Polymerization was performed by the same procedure as in Synthesis Example 8 except that 14.31 g (0.04 mol) of tri-n-propoxy(trimethylsiloxy)zirconium was changed to 13.12 g (0.04 mol) of tetrapropoxyzirconium. The polymetalloxane solution obtained was uniformly yellow and transparent. The solid concentration of the polymetalloxane solution obtained was determined and, then, DMIB was added such that the solid concentration became 25 wt %, to obtain a polymetalloxane (A-16) solution. The weight-average molecular weight (Mw) of the polymetalloxane (A-16) was 58,000 in terms of polystyrene.

### Synthesis Example 23: Synthesis of Zirconium Compound (M-7)

Into a three-necked flask having a capacity of 500 ml, 32.8 g (0.1 mol) of tetrapropoxyzirconium was fed, and the flask was immersed in an oil bath at 40° C. The resulting mixture was stirred for 30 minutes. Thereafter, using a dropping funnel, 13.0 g (0.1 mol) of ethyl acetoacetate was added over a period of 1 hour and, after the addition, the mixture was stirred for additional 1 hour. The contents of the flask were transferred to a 200 ml recovery flask, and propanol thus formed was distilled off under reduced pressure to obtain a yellow liquid zirconium compound (M-7).

This zirconium compound (M-7) was analyzed by FT-IR. An absorption peak of C═O (1600 cm⁻¹) and an absorption peak of C═C (1530 cm⁻¹), which were derived from the formation of a chelate ring with the ethyl acetoacetate, were observed, but an absorption peak of C═O (1712 cm⁻¹) derived from the ethyl acetoacetate before reaction was not observed, thus verifying that the zirconium compound (M-7) obtained was zirconium tri-n-propoxymonoethylacetoacetate.

### Synthesis Example 24: Polymetalloxane (A-17)

Polymerization was performed by the same procedure as in Synthesis Example 8 except that the amount of tri-n-propoxy(trimethylsiloxy)zirconium was changed to 14.31 g (0.04 mol), and that the amount of zirconium tri-n-propoxymonoethylacetoacetate was changed to 14.76 g (0.04 mol). When the solution 2 was added dropwise, the resulting solution looked a little cloudy, but the polymetalloxane solution obtained was uniformly yellow and transparent. The solid concentration of the polymetalloxane solution obtained was determined and, then, DMIB was added such that the solid concentration became 25 wt %, to obtain a polymetalloxane (A-17) solution. The weight-average molecular weight (Mw) of the polymetalloxane (A-17) was 47,000 in terms of polystyrene.

TABLE 2

| | | Solution 1 | | |
|---|---|---|---|---|
| | | Metal Alkoxide 1 | | |
| | | | Added | Metal Alkoxide 2 |
| | | Kind | Amount | Kind |
| Synthesis | Polymetalloxane | Zirconium tri-n- | 3.68 g | Aluminum di-s- |
| Example 7 | (A-1) Solution | propoxymonoacetylacetonate | (0.01 mol) | butoxymonoethylacetoacetate |
| Synthesis | Polymetalloxane | Zirconium tri-n- | 14.70 g | Aluminum di-s- |
| Example 8 | (A-2) Solution | propoxymonoacetylacetonate | (0.04 mol) | butoxymonoethylacetoacetate |
| Synthesis | Polymetalloxane | Zirconium tri-n- | 22.06 g | Aluminum di-s- |
| Example 9 | (A-3) Solution | propoxymonoacetylacetonate | (0.06 mol) | butoxymonoethylacetoacetate |
| Synthesis | Polymetalloxane | Zirconium tri-n- | 33.08 g | Aluminum di-s- |
| Example 10 | (A-4) Solution | propoxymonoacetylacetonate | (0.09 mol) | butoxymonoethylacetoacetate |
| Synthesis | Polymetalloxane | Zirconium tri-n- | 14.70 g | Di-s-butoxy(trimethyl- |
| Example 11 | (A-5) Solution | propoxymonoacetylacetonate | (0.04 mol) | siloxy)aluminum |
| Synthesis | Polymetalloxane | Tri-n-propoxy | 14.31 g | Aluminum di-s- |
| Example 12 | (A-6) Solution | (trimethylsiloxy)zirconium | (0.04 mol) | butoxymonoethylacetoacetate |
| Synthesis | Polymetalloxane | Zirconium tri-n | 3.68 g | Titanium tri-n- |
| Example 13 | (A-7) Solution | propoxymonoacetylacetonate | (0.01 mol) | butoxymonoacetylacetonate |
| Synthesis | Polymetalloxane | Zirconium tri-n- | 14.70 g | Titanium tri-n- |
| Example 14 | (A-8) Solution | propoxymonoacetylacetonate | (0.04 mol) | butoxymonoacetylacetonate |
| Synthesis | Polymetalloxane | Zirconium tri-n- | 22.06 g | Titanium tri-n- |
| Example 15 | (A-9) Solution | propoxymonoacetylacetonate | (0.06 mol) | butoxymonoacetylacetonate |
| Synthesis | Polymetalloxane | Zirconium tri-n- | 33.08 g | Titanium tri-n- |
| Example 16 | (A-10) Solution | propoxymonoacetylacetonate | (0.09 mol) | butoxymonoacetylacetonate |
| Synthesis | Polymetalloxane | Zirconium tri-n- | 14.70 g | Tri-n-butoxy(trimethyl- |
| Example 17 | (A-11) Solution | propoxymonoacetylacetonate | (0.04 mol) | siloxy)titanium |
| Synthesis | Polymetalloxane | Tri-n-propoxy | 14.31 g | Titanium tri-n- |
| Example 18 | (A-12) Solution | (trimethylsiloxy)zirconium | (0.04 mol) | butoxymonoacetylacetonate |
| Synthesis | Polymetalloxane | Tri-n-propoxy | 14.31 g | Di-s-butoxy(trimethyl- |
| Example 19 | (A-13) Solution | (trimethylsiloxy)zirconium | (0.04 mol) | siloxy)aluminum |
| Synthesis | Polymetalloxane | Tetrabutoxytitanium | 34.03 g | — |
| Example 20 | (A-14) Solution | | (0.10 mol) | |
| Synthesis | Polymetalloxane | Zirconium tri-n- | 14.70 g | Aluminum di-s- |
| Example 21 | (A-15) Solution | propoxymonoacetylacetonate | (0.04 mol) | butoxymonoethylacetoacetate |
| Synthesis | Polymetalloxane | Tetrapropoxyzirconium | 13.12 g | Aluminum di-s- |
| Example 22 | (A-16) Solution | | (0.04 mol) | butoxymonoethylacetoacetate |
| Synthesis | Polymetalloxane | Zirconium tri-n- | 14.76 g | Aluminum di-s- |
| Example 24 | (A-17) Solution | propoxymonoethylacetoacetate | (0.04 mol) | butoxymonoethylacetoacetate |

| | Solution 1 | | Solution 2 | | |
|---|---|---|---|---|---|
| | Metal Alkoxide 2 | | | Water- | |
| | Added | | | diluting | Polymerization |
| | Amount | Solvent | Water | Solvent | Catalyst |
| Synthesis | 27.21 g | DMIB | 3.78 g | IPA50 g | Tributylamine, |
| Example 7 | (0.09 mol) | 30.00 g | (0.21 mol) | | 1.85 g (0.01 mol) |
| Synthesis | 18.14 g | DMIB | 4.32 g | IPA50 g | Tributylamine, |
| Example 8 | (0.06 mol) | 30.00 g | (0.24 mol) | | 1.85 g (0.01 mol) |
| Synthesis | 12.09 g | DMIB | 4.69 g | IPA50 g | Tributylamine, |
| Example 9 | (0.04 mol) | 30.00 g | (0.26 mol) | | 1.85 g (0.01 mol) |
| Synthesis | 3.02 g | DMIB | 5.23 g | IPA50 g | Tributylamine, |
| Example 10 | (0.01 mol) | 30.00 g | (0.29 mol) | | 1.85 g (0.01 mol) |
| Synthesis | 15.74 g | DMIB | 4.32 g | IPA50 g | Tributylamine, |
| Example 11 | (0.06 mol) | 30.00 g | (0.24 mol) | | 1.85 g (0.01 mol) |
| Synthesis | 18.14 g | DMIB | 4.32 g | IPA50 g | Tributylamine, |
| Example 12 | (0.06 mol) | 30.00 g | (0.24 mol) | | 1.85 g (0.01 mol) |
| Synthesis | 32.97 g | DMIB | 5.41 g | IPA50 g | Tributylamine, |
| Example 13 | (0.09 mol) | 30.00 g | (0.30 mol) | | 1.85 g (0.01 mol) |
| Synthesis | 21.98 g | DMIB | 5.41 g | IPA50 g | Tributylamine, |
| Example 14 | (0.06 mol) | 30.00 g | (0.30 mol) | | 1.85 g (0.01 mol) |
| Synthesis | 14.65 g | DMIB | 5.41 g | IPA50 g | Tributylamine, |
| Example 15 | (0.04 mol) | 30.00 g | (0.30 mol) | | 1.85 g (0.01 mol) |
| Synthesis | 3.66 g | DMIB | 5.41 g | IPA50 g | Tributylamine, |
| Example 16 | (0.01 mol) | 30.00 g | (0.30 mol) | | 1.85 g (0.01 mol) |
| Synthesis | 21.38 g | DMIB | 5.41 g | IPA50 g | Tributylamine, |
| Example 17 | (0.06 mol) | 30.00 g | (0.30 mol) | | 1.85 g (0.01 mol) |
| Synthesis | 21.98 g | DMIB | 5.41 g | IPA50 g | Tributylamine, |
| Example 18 | (0.06 mol) | 30.00 g | (0.30 mol) | | 1.85 g (0.01 mol) |
| Synthesis | 15.74 g | DMIB | 4.32 g | IPA50 g | Tributylamine, |
| Example 19 | (0.06 mol) | 30.00 g | (0.24 mol) | | 1.85 g (0.01 mol) |
| Synthesis | — | n-Butanol | 3.06 g | — | — |
| Example 20 | | 50.00 g | (0.17 mol) | | |
| Synthesis | 18.14 g | DMIB | 4.32 g | IPA50 g | Tributylamine, |
| Example 21 | (0.06 mol) | 30.00 g | (0.24 mol) | | 1.85 g (0.01 mol) |
| Synthesis | 18.14 g | DMIB | 4.32 g | IPA50 g | Tributylamine, |
| Example 22 | (0.06 mol) | 30.00 g | (0.24 mol) | | 1.85 g (0.01 mol) |
| Synthesis | 18.14 g | DMIB | 4.32 g | IPA50 g | Tributylamine, |
| Example 24 | (0.06 mol) | 30.00 g | (0.24 mol) | | 1.85 g (0.01 mol) |

TABLE 3

| | | Structure of Polymer Obtained | | | | | | |
|---|---|---|---|---|---|---|---|---|
| | | General Formula (1-1) | | | | | | |
| | | M1 | m | a | R1 | L1 | R3 | R4 |
| Synthesis | Polymetalloxane | Zr | 4 | 1 | n-Propyl | General | Methyl | Methyl |
| Example 7 | (A-1) Solution | | | | Group | Formula (2) | Group | Group |
| Synthesis | Polymetalloxane | Zr | 4 | 1 | n-Propyl | General | Methyl | Methyl |
| Example 8 | (A-2) Solution | | | | Group | Formula (2) | Group | Group |
| Synthesis | Polymetalloxane | Zr | 4 | 1 | n-Propyl | General | Methyl | Methyl |
| Example 9 | (A-3) Solution | | | | Group | Formula (2) | Group | Group |
| Synthesis | Polymetalloxane | Zr | 4 | 1 | n-Propyl | General | Methyl | Methyl |
| Example 10 | (A-4) Solution | | | | Group | Formula (2) | Group | Group |
| Synthesis | Polymetalloxane | Zr | 4 | 1 | n-Propyl | General | Methyl | Methyl |
| Example 11 | (A-5) Solution | | | | Group | Formula (2) | Group | Group |
| Synthesis | Polymetalloxane | Zr | 4 | 1 | n-Propyl | Trimethylsiloxy | — | — |
| Example 12 | (A-6) Solution | | | | Group | Group | | |
| Synthesis | Polymetalloxane | Zr | 4 | 1 | n-Propyl | General | Methyl | Methyl |
| Example 13 | (A-7) Solution | | | | Group | Formula (2) | Group | Group |
| Synthesis | Polymetalloxane | Zr | 4 | 1 | n-Propyl | General | Methyl | Methyl |
| Example 14 | (A-8) Solution | | | | Group | Formula (2) | Group | Group |
| Synthesis | Polymetalloxane | Zr | 4 | 1 | n-Propyl | General | Methyl | Methyl |
| Example 15 | (A-9) Solution | | | | Group | Formula (2) | Group | Group |
| Synthesis | Polymetalloxane | Zr | 4 | 1 | n-Propyl | General | Methyl | Methyl |
| Example 16 | (A-10) Solution | | | | Group | Formula (2) | Group | Group |
| Synthesis | Polymetalloxane | Zr | 4 | 1 | n-Propyl | General | Methyl | Methyl |
| Example 17 | (A-11) Solution | | | | Group | Formula (2) | Group | Group |
| Synthesis | Polymetalloxane | Zr | 4 | 1 | n-Propyl | Trimethylsiloxy | — | — |
| Example 18 | (A-12) Solution | | | | Group | Group | | |
| Synthesis | Polymetalloxane | Zr | 4 | 1 | n-Propyl | Trimethylsiloxy | — | — |
| Example 19 | (A-13) Solution | | | | Group | Group | | |
| Synthesis | Polymetalloxane | Ti | 4 | 1 | Butyl | Butoxy | — | — |
| Example 20 | (A-14) Solution | | | | Group | Group | | |
| Synthesis | Polymetalloxane | Zr | 4 | 1 | n-Propyl | General | Methyl | Methyl |
| Example 21 | (A-15) Solution | | | | Group | Formula (2) | Group | Group |
| Synthesis | Polymetalloxane | Zr | 4 | 1 | n-Propyl | n-Propoxy | — | — |
| Example 22 | (A-16) Solution | | | | Group | Group | | |
| Synthesis | Polymetalloxane | Zr | 4 | 1 | n-Propyl | General | Methyl | Ethoxy |
| Example 24 | (A-17) Solution | | | | Group | Formula (2) | Group | Group |

| | | | | | | | | Weight- |
|---|---|---|---|---|---|---|---|---|
| | Structure of Polymer Obtained | | | | | | | average |
| | General Formula (1-2) | | | | | | | Molecular |
| | M2 | n | b | R2 | L2 | R3 | R4 | Weight |
| Synthesis | Al | 3 | 1 | — | General | Methyl | Ethoxy | 1,120,000 |
| Example 7 | | | | | Formula (2) | Group | Group | |
| Synthesis | Al | 3 | 1 | — | General | Methyl | Ethoxy | 1,230,000 |
| Example 8 | | | | | Formula (2) | Group | Group | |
| Synthesis | Al | 3 | 1 | — | General | Methyl | Ethoxy | 1,300,000 |
| Example 9 | | | | | Formula (2) | Group | Group | |
| Synthesis | Al | 3 | 1 | — | General | Methyl | Ethoxy | 1,340,000 |
| Example 10 | | | | | Formula (2) | Group | Group | |
| Synthesis | Al | 3 | 1 | — | Trimethylsiloxy | — | — | 860,000 |
| Example 11 | | | | | Group | | | |
| Synthesis | Al | 3 | 1 | — | General | Methyl | Ethoxy | 720,000 |
| Example 12 | | | | | Formula (2) | Group | Group | |
| Synthesis | Ti | 4 | 1 | n-Butoxy | General | Methyl | Methyl | 1,240,000 |
| Example 13 | | | | Group | Formula (2) | Group | Group | |
| Synthesis | Ti | 4 | 1 | n-Butoxy | General | Methyl | Methyl | 1,310,000 |
| Example 14 | | | | Group | Formula (2) | Group | Group | |
| Synthesis | Ti | 4 | 1 | n-Butoxy | General | Methyl | Methyl | 1,360,000 |
| Example 15 | | | | Group | Formula (2) | Group | Group | |
| Synthesis | Ti | 4 | 1 | n-Butoxy | General | Methyl | Methyl | 1,410,000 |
| Example 16 | | | | Group | Formula (2) | Group | Group | |
| Synthesis | Ti | 4 | 1 | n-Butoxy | Trimethylsiloxy | — | — | 1,110,000 |
| Example 17 | | | | Group | Group | | | |
| Synthesis | Ti | 4 | 1 | n-Butoxy | General | Methyl | Methyl | 1,090,000 |
| Example 18 | | | | Group | Formula (2) | Group | Group | |
| Synthesis | Al | 3 | 1 | — | Trimethylsiloxy | — | — | 500,000 |
| Example 19 | | | | | Group | | | |
| Synthesis | none | | | | | | | 1,700 |
| Example 20 | | | | | | | | |
| Synthesis | Al | 3 | 1 | — | General | Methyl | Ethoxy | 26,000 |
| Example 21 | | | | | Formula (2) | Group | Group | |
| Synthesis | Al | 3 | 1 | — | General | Methyl | Ethoxy | 58,000 |
| Example 22 | | | | | Formula (2) | Group | Group | |
| Synthesis | Al | 3 | 1 | — | General | Methyl | Ethoxy | 47,000 |
| Example 24 | | | | | Formula (2) | Group | Group | |

### Example 1

Two 4-inch silicon wafers were spin-coated with the polymetalloxane (A-1) solution obtained as above-mentioned and having a solid concentration of 25 wt %, using a spin coater (“1H-360S (tradename)” manufactured by Mikasa Co., Ltd.), immediately after the solution was produced such that the film thicknesses after curing became 0.5 μm and 0.7 μm respectively. Thus, coating films were formed. The resulting base plates having a coating film formed thereon were heated at 100° C. for 5 minutes using a hot plate (“SCW-636 (tradename)” manufactured by Dainippon Screen Mfg. Co., Ltd.), to form prebaked films, which were further cured at 300° C. for 5 minutes using the hot plate to produce cured films. In this manner, cured films having a film thickness of 0.5 μm and 0.7 μm respectively were produced. The film thickness was measured using an optical interferometric film-thickness meter (Lambda Ace STM602, manufactured by Dainippon Screen Mfg. Co., Ltd.).

In addition, the above-mentioned polymetalloxane (A-1) solution was stored at 23° C. for 7 days. Then, in the same manner as above-mentioned, cured films having a film thickness of 0.5 μm and 0.7 μm respectively were produced.

### Evaluation of Refractive Index of Cured Film

Using a spectroscopic ellipsometer (FE5000, manufactured by Otsuka Electronics Co., Ltd.), the resulting cured film having a film thickness of 0.5 μm was used to measure a change in the state of polarization of a reflected light from the cured film, and a phase difference from the incident light and a spectrum of amplitude reflectance were obtained. The temperature during the measurement was set at 22° C. By fitting the dielectric function of the computation model such that it approached the obtained spectrum, a refractive index spectrum was obtained. By reading the refractive index value at a wavelength of 550 nm from the refractive index spectrum obtained, the refractive index of the cured film was measured.

### Evaluation of Crack Resistance of Cured Film

The cured film produced immediately after the production of the polymetalloxane solution obtained as above-mentioned and the cured film produced after the polymetalloxane solution was stored at 23° C. for 7 days were each evaluated for crack resistance. The results were rated in the following five steps. Rating 4 or above is regarded as acceptable.
5: No crack is observed under an optical microscope (magnification: 5 times)
4: Cracks are slightly observed under an optical microscope (magnification: 5 times)
3: Cracks are clearly observed under an optical microscope (magnification: 5 times)
2: Cracks are slightly observed by normal visual observation
1: Cracks are clearly observed by normal visual observation.

The results of evaluation of the refractive index and crack resistance are tabulated in Table 4.

### Examples 2 to 13 and Comparative Examples 1 to 2

The polymetalloxane solutions listed in Table 4 were evaluated the same as in Example 1. The evaluation results are tabulated in Table 3.

TABLE 4

| | | | | Exam- | Exam- | Exam- | Exam- | Exam- | Exam- |
|---|---|---|---|---|---|---|---|---|---|
| | | | | ple 1 | ple 2 | ple 3 | ple 4 | ple 5 | ple 6 |
| Compo- | Polymetall- | | Kind | A-1 | A-2 | A-3 | A-4 | A-5 | A-6 |
| sition | oxanc | | Weight- | 1,120,000 | 1,230,000 | 1,300,000 | 1,340,000 | 860,000 | 720,000 |
| | | | average | | | | | | |
| | | | Molec- | | | | | | |
| | | | ular | | | | | | |
| | | | Weight | | | | | | |
| | | | M1/M2 | Zr/Al | Zr/Al | Zr/Al | Zr/Al | Zr/Al | Zr/Al |
| | | | Kinds | | | | | | |
| | | | M1/M2 | 1/9 | 4/6 | 6/4 | 9/1 | 4/6 | 4/6 |
| | | | Molar | | | | | | |
| | | | Ratio | | | | | | |
| Eval- | Refractive Index | | | 1.53 | 1.58 | 1.61 | 1.66 | 1.58 | 1.57 |
| uation | Crack | Cured | Film | 5 | 5 | 5 | 5 | 5 | 5 |
| Results | Resis- | Film | Thick- | | | | | | |
| | tance | Produced | ness | | | | | | |
| | | Immediately | 0.5 μm | | | | | | |
| | | after | Film | 5 | 5 | 5 | 5 | 5 | 5 |
| | | Preparation | Thick- | | | | | | |
| | | of | ness | | | | | | |
| | | Solution | 0.7 μm | | | | | | |
| | | Cured | Film | 5 | 5 | 5 | 5 | 5 | 4 |
| | | Film | Thick- | | | | | | |
| | | Produced | ness | | | | | | |
| | | after | 0.5 μm | | | | | | |
| | | Solution | Film | 5 | 5 | 5 | 5 | 4 | 4 |
| | | was Stored | Thick- | | | | | | |
| | | at 23° C. | ness | | | | | | |
| | | for 7 days | 0.7 μm | | | | | | |
| | | | | Exam- | Exam- | Exam- | Exam- | Exam- | Exam- |
| | | | | ple 7 | ple 8 | ple 9 | ple 10 | ple 11 | ple 12 |
| Compo- | Polymetall- | | Kind | A-7 | A-8 | A-9 | A-10 | A-11 | A-12 |
| sition | oxanc | | Weight- | 1,240,000 | 1,310,000 | 1,360,000 | 1,410,000 | 1,110,000 | 1,090,000 |
| | | | average | | | | | | |
| | | | Molec- | | | | | | |
| | | | ular | | | | | | |
| | | | Weight | | | | | | |
| | | | M1/M2 | Zr/Ti | Zr/Ti | Zr/Ti | Zr/Ti | Zr/Ti | Zr/Ti |
| | | | Kinds | | | | | | |
| | | | M1/M2 | 1/9 | 4/6 | 6/4 | 9/1 | 4/6 | 4/6 |
| | | | Molar | | | | | | |
| | | | Ratio | | | | | | |
| Eval- | Refractive Index | | | 1.71 | 1.74 | 1.76 | 1.80 | 1.74 | 1.72 |
| uation | Crack | Cured | Film | 5 | 5 | 5 | 5 | 5 | 5 |
| Results | Resis- | Film | Thick- | | | | | | |
| | tance | Produced | ness | | | | | | |
| | | Immediately | 0.5 μm | | | | | | |
| | | after | Film | 5 | 5 | 5 | 5 | 5 | 5 |
| | | Preparation | Thick- | | | | | | |
| | | of | ness | | | | | | |
| | | Solution | 0.7 μm | | | | | | |
| | | Cured | Film | 5 | 5 | 5 | 5 | 5 | 4 |
| | | Film | Thick- | | | | | | |
| | | Produced | ness | | | | | | |
| | | after | 0.5 μm | | | | | | |
| | | Solution | Film | 5 | 5 | 5 | 5 | 5 | 4 |
| | | was Stored | Thick- | | | | | | |
| | | at 23° C. | ness | | | | | | |
| | | for 7 days | 0.7 μm | | | | | | |

| | | | | | Compar- | Compar- | Compar- | Compar- |
|---|---|---|---|---|---|---|---|---|
| | | | | | ative | ative | ative | ative |
| | | | | Exam- | Exam- | Exam- | Exam- | Exam- |
| | | | | ple 13 | ple 1 | ple 2 | ple 3 | ple 4 |
| Compo- | Polymetall- | | Kind | A-17 | A-13 | A-14 | A-15 | A-16 |
| sition | oxanc | | Weight- | 47,000 | 500,000 | 1,700 | 26,000 | 58,000 |
| | | | average | | | | | |
| | | | Molec- | | | | | |
| | | | ular | | | | | |
| | | | Weight | | | | | |
| | | | M1/M2 | Zr/Al | Zr/Al | Ti | Zr/Al | Zr/Al |
| | | | Kinds | | | | | |
| | | | M1/M2 | 4/6 | 4/6 | — | 4/6 | 4/6 |
| | | | Molar | | | | | |
| | | | Ratio | | | | | |
| Eval- | Refractive Index | | | 1.58 | 1.56 | 1.65 | 1.58 | 1.58 |
| uation | Crack | Cured | Film | 5 | 4 | 1 | 3 | 4 |
| Results | Resis- | Film | Thick- | | | | | |
| | tance | Produced | ness | | | | | |
| | | Immediately | 0.5 μm | | | | | |
| | | after | Film | 5 | 1 | 1 | 3 | 2 |
| | | Preparation | Thick- | | | | | |
| | | of | ness | | | | | |
| | | Solution | 0.7 μm | | | | | |
| | | Cured | Film | 4 | 1 | 1 | 3 | 2 |
| | | Film | Thick- | | | | | |
| | | Produced | ness | | | | | |
| | | after | 0.5 μm | | | | | |
| | | Solution | Film | 3 | 1 | 1 | 2 | 1 |
| | | was Stored | Thick- | | | | | |
| | | at 23° C. | ness | | | | | |
| | | for 7 days | 0.7 μm | | | | | |

### Method of Measuring Peak Intensity of Zr Crystal

The cured film obtained in each of the Examples was shaved, using a spatula, and the resulting pieces of the cured film were powdered. The resulting powder was placed in an aluminum cup, and baked at 700° C. for 30 minutes. The crystal intensity of the powder baked was measured, using an X-ray diffractometer D8 ADVANCE manufactured by Bruker Corporation. When this was done, the crystallization peak assumed to be derived from the tetragonal crystal of Zr was observed at 30.1<20<30.3. A value obtained by dividing this peak intensity measurement by the ratio of Zr in the metal element was regarded as the peak intensity of the Zr crystal, in which the ratio is calculated from the fed amount of the raw material used to produce the cured film.

The results obtained by analysis using the cured films in Examples 1 to 4 revealed that the peak intensity of the Zr crystal in each Example was 8,000 counts/mol % or less. The intensities in Example 5, Example 6, and Example 13 were 11,407 counts/mol %, 12,407 counts/mol %, and 8,905 counts/mol % respectively. This is believed to be due to the influence: the crystallization of ZrO₂ is inhibited by the randomness of the metal. On the other hand, Comparative Example 1, with 27,756 counts/mol %, strongly exhibited the crystallization peak of the ZrO₂ tetragonal crystal, verifying the crystal growth. In this regard, no peak derived from the cubical crystal of ZrO₂ was observed in any of the cured films.

1-20. (canceled)

21. A polymetalloxane comprising structural units represented by general formulae (1-1) and (1-2), and having a weight-average molecular weight of 30,000 or more and 2,000,000 or less; 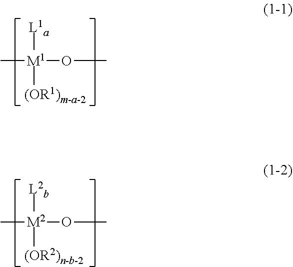
wherein, in general formulae (1-1) and (1-2), M¹ and M² independently represent different metal atoms each selected from the group consisting of Al, Sc, Ti, V, Cr, Mn, Fe, Co, Ni, Cu, Zn, Ga, Ge, Y, Zr, Nb, Mo, In, Sn, Sb, Hf, Ta, W, and Bi; L¹ and L² are each independently a group selected from the group consisting of an allyloxy group, an aryloxy group, and a trialkylsiloxy group; L¹ and L² may be the same or different, and at least one thereof is an allyloxy group or an aryloxy group; R¹ and R² are each independently a hydrogen atom, a C₁₋₁₂ alkyl group, or a group having a metalloxane bond; m is an integer that represents the valence of the metal atom M¹, and a is an integer of 1 to (m−2); and n is an integer that represents the valence of the metal atom M², and b is an integer of 1 to (n−2).

22. The polymetalloxane according to claim 21, wherein, in general formulae (1-1) and (1-2), at least one of L¹ or L² is a group represented by general formula (2); 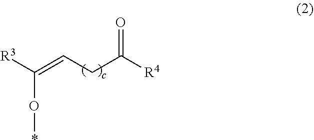
wherein, in general formula (2), R³ and R⁴ are each independently a hydrogen atom, a hydroxy group, a C₁₋₁₂ alkyl group, a C₅₋₁₂ alicyclic alkyl group, a C₁₋₁₂ alkoxy group, a C₆₋₁₂ aryl group, or a C₆₋₁₂ aryloxy group, and c is an integer of 0 to 2.

23. The polymetalloxane according to claim 22, wherein c is 0.

24. The polymetalloxane according to claim 22, wherein, in general formulae (1-1) and (1-2), L¹ and L² are each a group represented by general formula (2), and L¹ and L² are different from each other in R³ and/or R⁴ in each constituent unit.

25. The polymetalloxane according to claim 21, wherein M¹ and M² are different metal atoms selected from the group consisting of Al, Ti, Y, Zr, Nb, and Sn.

26. The polymetalloxane according to claim 21, wherein, in general formulae (1-1) and (1-2), M¹ is Zr, and M² is Al or Ti.

27. The polymetalloxane according to claim 21, wherein, in general formulae (1-1) and (1-2), M¹ is Zr, and M² is Al.

28. The polymetalloxane according to claim 21, wherein, in general formulae (1-1) and (1-2), M¹ is Zr, and M² is Ti.

29. The polymetalloxane according to claim 21, wherein, in general formula (1-1), M¹ is Zr, L¹ is a group represented by general formula (2), and R³ and R⁴ are each a C₁₋₁₂ alkyl group; 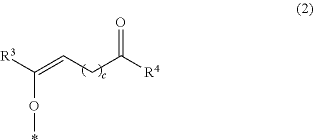
wherein, in general formula (2), R³ and R⁴ are each independently a hydrogen atom, a hydroxy group, a C₁₋₁₂ alkyl group, a C₅₋₁₂ alicyclic alkyl group, a C₁₋₁₂ alkoxy group, a C₆₋₁₂ aryl group, or a C₆₋₁₂ aryloxy group, and c is an integer of 0 to 2.

30. The polymetalloxane according to claim 21, wherein, in general formula (1-2), M² is Al, L¹ is a group represented by general formula (2), and at least one of R³ or R⁴ is a C₁₋₁₂ alkoxy group; 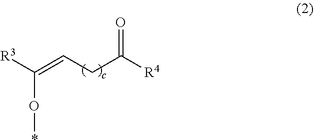
wherein, in general formula (2), R³ and R⁴ are each independently a hydrogen atom, a hydroxy group, a C₁₋₁₂ alkyl group, a C₅₋₁₂ alicyclic alkyl group, a C₁₋₁₂ alkoxy group, a C₆₋₁₂ aryl group, or a C₆₋₁₂ aryloxy group, and c is an integer of 0 to 2.

31. A cured film or a baked film, formed by curing the polymetalloxane according to claim 21.

32. An oxide ceramic film comprising two or more metals, wherein at least one of the metals is Zr, the ratio of Zr in the metal elements is 5 to 70 mol %, and the largest peak intensity of the Zr crystal of 30.1<20<30.3 is 15,000 counts/mol % or less.

33. A method of producing a polymetalloxane, comprising a step of polycondensing a compound represented by general formula (3) or a hydrolysate of the compound to obtain a polymetalloxane having a weight-average molecular weight of 30,000 or more and 2,000,000 or less; 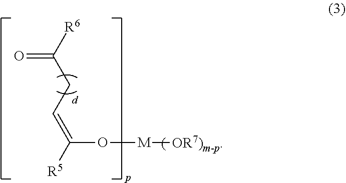
wherein, in general formula (3), R⁵ and R⁶ are each independently a hydrogen atom, a hydroxy group, a C₁₋₁₂ alkyl group, a C₅₋₁₂ alicyclic alkyl group, a C₁₋₁₂ alkoxy group, a C₆₋₁₂ aryl group, or a C₆₋₁₂ aryloxy group; R⁷ is a hydrogen atom, a C₁₋₁₂ alkyl group, or a group having a metalloxane bond; and, when R⁵ to R⁷, two or more each, are present, the units may be the same or different in each plurality; M represents a metal atom selected from the group consisting of Al, Sc, Ti, V, Cr, Mn, Fe, Co, Ni, Cu, Zn, Ga, Ge, Y, Zr, Nb, Mo, In, Sn, Sb, Hf, Ta, W, and Bi; and p is an integer that represents the valence of a metal atom M, p is an integer of 1 to (p−1), and d is an integer of 0 to 2.

34. A composition comprising the polymetalloxane according to claim 21.

35. A method of producing a cured film or a baked film, comprising a step of heating the polymetalloxane according to claim 21.

36. A member comprising the cured film or the baked film according to claim 31.

37. An electronic component comprising the member according to claim 36.

38. A fiber composed of the polymetalloxane according to claim 21.

39. A method of producing a fiber, comprising a step of spinning the polymetalloxane according to claim 21.

40. A method of producing a metal oxide fiber, comprising a step of baking a fiber obtained by spinning the polymetalloxane according to claim 21.

41. A method of producing a cured film or a baked film, comprising a step of heating the composition according to claim 34.

42. A fiber composed of the composition according to claim 34.

43. A method of producing a fiber, comprising a step of spinning the composition according to claim 34.

44. A method of producing a metal oxide fiber, comprising a step of baking a fiber obtained by spinning the composition according to claim 34.
